(19) United States
(12) Patent Application Publication
(10) Pub. No.: US 2008/0246583 A1
(43) Pub. Date: Oct. 9, 2008

(54) Access Control System

(75) Inventors: Christopher Ian Blake, West Ryde (AU); Karthik Sivaram, Burwood (AU)

Correspondence Address: BARNES & THORNBURG LLP, 11 SOUTH MERIDIAN, INDIANAPOLIS, IN, 46204, US

(73) Assignee: BQT SOLUTIONS (AUSTRALIA) PTY LTD, North Ryde (AU)

(21) Appl. No.: 10/590,673

(22) PCT Filed: Feb. 28, 2005
(86) PCT No.: PCT/AU2005/000255

§ 371 Date: Jun. 18, 2008

(30) Foreign Application Priority Data
Feb. 27, 2004 (AU) 2004901016

(51) Int. Cl. G05B 19/00

(52) U.S. Cl. 340/5.7

(57) ABSTRACT

A method of switching a door latch in a secure area, a relay module, and an access control system are disclosed. Encrypted communications from a reader in an unsecured area are decrypted, and the decrypted communications are compared to an expected code. A micro-controller may implement the decrypting and comparing steps. Power is switched to actuate the door latch if the comparison of the decrypted communications and the expected code indicates a correct match. A relay coupled to the micro-controller may implement the switching step. The relay module and the door latch may be a single module. The method may further comprise the step of receiving the encrypted communications from the reader. At least one buffer coupled to the micro-controller may implement the receiving step.

### CROSS-REFERENCE TO RELATED APPLICATIONS

This application is a U.S. national counterpart application of international application serial no. PCT/AU2005/000255 filed Feb. 28, 2005, which claims priority to Australian application serial no. 2004/901016 filed Feb. 27, 2004.

### FIELD OF THE INVENTION

The present invention relates generally to security Systems and in particular to access control systems.

### BACKGROUND

Existing controlled access systems utilize a controller in a secure area that is connected to a relay coupled to a door lock that is also in tie secure area. Normally, the relay is on the controller. The controller is coupled to a reader, where the reader is in an unsecured area. Another configuration involves a reader with a relay in the same unit, where the relay is in the unsecured area. FIGS. 7A and 7B are block diagrams of each of these systems, respectively

FIG. 7A illustrates a controller 740 with a relay on board in the secure area 720. The reader 730 is located in the unsecured area 710 and communicates with the controller 740, for example, using Wiegand communications. The controller 740 with the relay is in turn coupled to a door latch 750 in the secure area 720. In operation, the reader 730 sends an access number to the controller 740, which looks up the number in a database and determines the access level that is appropriate. If access is granted, the controller 740 enables the relay to activate the door latch 750.

FIG. 7B illustrates a reader 760 with the database and the relay on board the reader in the unsecured area 710, while the door latch 780 is in the secure area 720. If the reader 760 determines that access is to be granted, the reader 760 enables the relay on board the reader 760 to activate the door latch 780.

Both of these systems have disadvantages. The system of FIG. 7A involves use of controllers that makes the security systems expensive and the use of Wiegand communications, where Wiegand is a known format and therefore a weak link. Wiegand lines are a “weak link” in the sense that Wiegand formats are normally known formats, such as 26 bits. A code generator is able to simulate sending codes to a controller if the reader is removed from the wall, for example, and Wiegand format signals may be sent down the Wiegand lines to defeat the system. The system of FIG. 7B involves a relay on board the reader. Thus, a 5V power supply for example may be used to activate the door relay from the unsecured area.

FIG. 8 is a block diagram of a general antipassback system 800 comprising a read only tag 810, a read only device 820, a control panel 830 and server software 840. Antipassback is a feature of access control systems that ensures that cardholders/tag holders are required to properly enter and exit areas by using their card/tag. The cardholder must flash their card at the entry and the exit. If the person fails to flash their card upon exit (e.g. by mistake or by tailgating), the person is denied entry on the next occasion for having violated rules by exiting without flashing the card. FIG. 9 is a flow diagram of the antipassback process 900 performed by the system 800 of FIG. 8. In step 910, a user flashes the read-only tag 810 to the read-only device 820 coupled to the control panel 830. In step 920, the control panel 840 contacts a server having server software. 840 coupled to the control panel 830. In step 930, the antipassback state is checked (on the server/control panel). In step 940, the antipassback state is updated.

### SUMMARY

In accordance with an aspect of the invention, there is provided a relay module for connection to a door latch in a secure area. The relay module comprises a micro-controller decrypting encrypted communications from a reader in an unsecured area and comparing the decrypted communications to an expected code, and a relay coupled to the micro-controller switching power to actuate the door latch if the comparison of the decrypted communications and the expected code indicates a correct match.

The relay module and the door latch may be a single module.

The micro-controller may enable the relay if the comparison indicates a correct match. If the relay is enabled, power runs through the door latch to unlock a door.

The relay module may further comprise at least one buffer coupled to the micro-controller for receiving the encrypted communications from the reader. The buffer protects the micro-controller from being damaged if a spike occurs in the communications between the reader and the relay module. The buffer may rectify any voltage level drop between the reader and the relay module.

In accordance with another aspect of the invention, there is provided a method of switching a door latch in a secure area. The method comprises the steps of decrypting encrypted communications from a reader in an unsecured area and comparing the decrypted communications to an expected code, and switching power to actuate the door latch if the comparison of the decrypted communications and the expected code indicates a correct match.

A micro-controller may implement the decrypting and comparing steps. A relay coupled to the micro-controller may implement the switching step. The relay module and the door latch may be a single module. The micro-controller enables the relay if the comparison indicates a correct match. If the relay is enabled, power runs through the door latch to unlock a door.

The method may further comprise the step of receiving the encrypted communications from the reader. At least one buffer coupled to the micro-controller may implement the receiving step. The buffer protects the micro-controller from being damaged if a spike occurs in the communications between the reader and the relay module. The buffer may rectify any voltage level drop between the reader and the relay module.

In accordance with a further aspect of the invention, there is provided an access control system, comprising: a reader located in an unsecured area for determining access rights in response to presentation of a card and generating encrypted communications; a relay module located in a secure area for receiving the encrypted communications from the reader, decrypting the encrypted communications, and comparing the decrypted communications to an expected code; a door latch coupled to the relay module, the door latch actuated by the relay module switching power if the comparison of the decrypted communications and the expected code indicates a correct match.

The generated encrypted communications comprises an access command for the relay module.

The door latch may be directly connected to the relay module. The relay module and the door latch may be a single module.

The reader may comprise logic functions and a database residing in the reader. The database may hold information including access times, users, hot-listing, holidays, and the like. The reader may be autonomous if communications are cut or a master computer is brought down.

The reader may be a smartcard reader and the card may be a smartcard. The smartcard may implement an anti-passback feature.

The reader may be a biometric reader.

The relay module may be a storage relay module.

The relay module may comprise: a micro-controller for decrypting encrypted communications from a reader in an unsecured area and for comparing the decrypted communications to an expected code; and a relay coupled to the micro-controller for switching power to actuate the door latch if the comparison of the decrypted communications and the expected code indicates a correct match.

The relay module may further comprise at least one buffer coupled to the micro-controller for receiving the encrypted communications from the reader.

The communications may be encrypted using 128-bit AES, 3DES, DES, or skipjack.

In accordance with still a further aspect of the invention, there is provided a method of controlling access to a secure area. The method comprises the steps of: determining access rights using a reader located in an unsecured area in response to presentation of a card and generating encrypted communications; receiving the encrypted communications from the reader using a relay module located in a secure area for, decrypting the encrypted communications, and comparing the decrypted communications to an expected code; actuating a door latch coupled to the relay module using the relay module by switching power if the comparison of the decrypted communications and the expected code indicates a correct match.

The generated encrypted communications may comprise an access command for the relay module.

The door latch may be directly connected to the relay module. The relay module and the door latch may be a single module.

The reader may comprise logic functions and a database residing in the reader. The database may hold information including access times, users, hot-listing, holidays, and the like. The reader may be autonomous if communications are cut or a master computer is brought down. The reader may be a smartcard reader, and the card may be a smartcard. The smartcard may implement an anti-passback feature.

The reader may be a biometric reader.

The relay module may be a storage relay module.

The relay module may comprise: a micro-controller for decrypting encrypted communications from a reader in an unsecured area and for comparing the decrypted communications to an expected code; and a relay coupled to the micro-controller for switching power to actuate the door latch if the comparison of the decrypted communications and the expected code indicates a correct match.

The relay module may further comprise at least one buffer coupled to the micro-controller for receiving the encrypted communications from the reader.

The communications may be encrypted using 128-bit AES, 3DES, DES, or skipjack.

In accordance with yet another aspect of the invention, there is provided a method of providing antipassback in an access control system. The method comprises the steps of: reading antipassback information from a read/write smartcard presented to a read/write reader; checking permissions using the read/write reader; and updating the read/write smartcard with updated antipassback information using the reader.

In accordance with still another aspect of the invention, there is provided a method of providing antipassback in an access control system. The method comprises the steps of: reading antipassback information from a read/write smartcard presented to a read/write reader; determining if the antipassback information passes an integrity check based on an entry/exit pattern; and if the antipassback information passes the integrity check, writing updated antipassback information to the read/write smartcard and granting access.

The method may further comprise the step of, if the antipassback information fails to satisfy the integrity check, denying access.

The antipassback may able to be disabled.

The antipassback may be normalized so that a cardholder may proceed through an antipassback area without violating antipassback rules.

A database of readers may be updated with an antipassback flag.

### BRIEF DESCRIPTION OF THE DRAWINGS

A number of embodiments of the invention are described hereinafter with reference to the drawings, in which:

FIG. 1 is a block diagram of an access control system in accordance with an embodiment of the invention;

FIG. 2 is a block diagram of an access control system in accordance with another embodiment of the invention;

FIG. 3 is a block diagram illustrating operation of the embodiments of FIGS. 1 and 2;

FIG. 4 is a block diagram illustrating the details of the relay module of FIG. 1;

FIG. 5 is a block diagram illustrating the configuration of an access control system with several readers;

FIG. 6 is a block diagram illustrating the configuration of an access control system with several readers using an RS485 hub;

FIGS. 7A and 7B are block diagrams illustrating operation of a controller with a relay on board and a reader with a relay on board, respectively;

FIG. 8 is a block diagram of a general antipassback system;

FIG. 9 is a flow diagram of the antipassback process performed by the system of FIG. 8;

FIG. 10 is a block diagram of an access control system with a relay module;

FIG. 11 is a block diagram of an access control system with a storage relay module;

FIG. 12 is a flow diagram the antipassback feature implemented in the access control system;

FIG. 13 is a detailed flow diagram of normal operation of the antipassback feature;

FIG. 14 is a detailed flow diagram of disabled operation of the antipassback feature;

FIG. 15 is a detailed flow diagram of normalized operation of the antipassback feature as implemented in a reader; and

FIG. 16 is a detailed flow diagram of normalized operation of the antipassback feature as implemented in a server, and

### DETAILED DESCRIPTION

The embodiments of the invention provide an access control system and software package. The access control system includes the following functionality: remote reader updating, encrypted communications, a relay module, and the ability to incorporate biometrics on a smartcard. Any of a number of readers may be practiced, such as the BQT Solutions BT816, BT843, and BT910 readers.

The embodiments of the invention have a number of advantageous features, including encrypted communications. The embodiments of the invention enable doors to be physically secured using a memory system that resides on a reader. In particular, the logic functions and the database reside on the reader. The database is contained within the reader and holds access times, users, hot-listing, holidays, etc. The reader is autonomous if communications are cut or the master computer is brought down. The resulting relay module increases security as the relay module enables encrypted communications

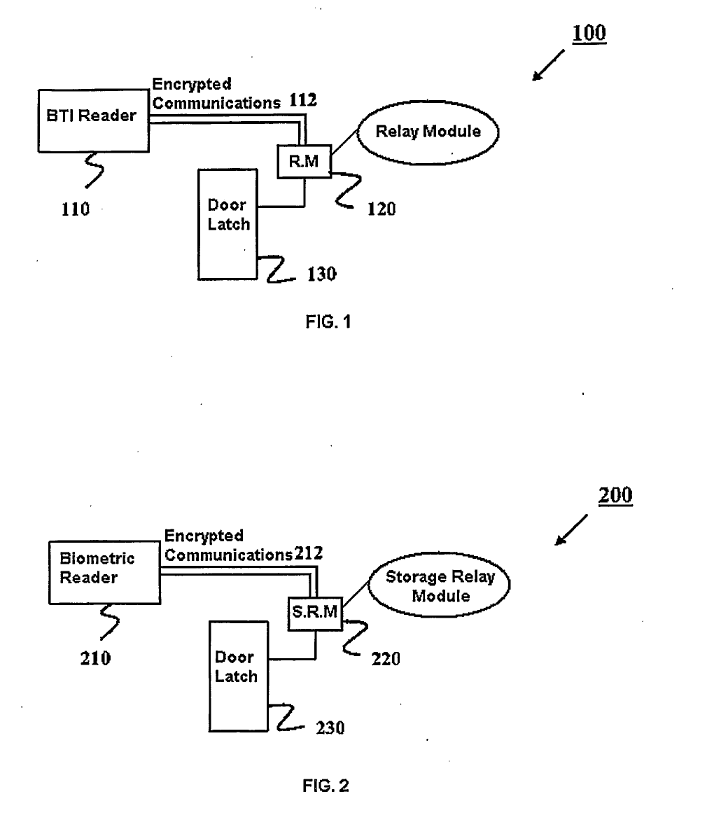

FIG. 1 is a block diagram of an access control system 100 in accordance with an embodiment of the invention comprising a smartcard reader 110, a relay module 120, and a door latch 130. In this embodiment, the door latch 130 and the relay module 120 are in the secure area, while the reader 110 is in the unsecured area. A smartcard may be used with the reader 110 to gain access to the secure area. If the smartcard is authorized for access, the relay module 120 actuates the door latch. Importantly, communications 112 between the reader 10 and the relay module 120 are encrypted. Any of a number of encryption techniques hereinafter may be practiced.

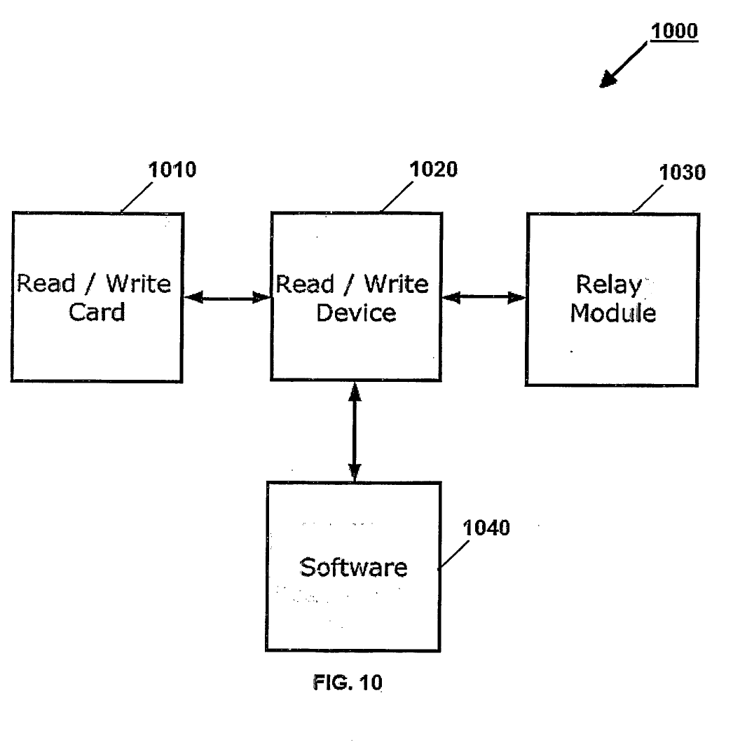

FIG. 10 is a block diagram of an access control system 1000 with a relay module 1030. A read/write card 1010 can be presented to a read/write device 1020, which is coupled to server software 1040 and the relay module 1030.

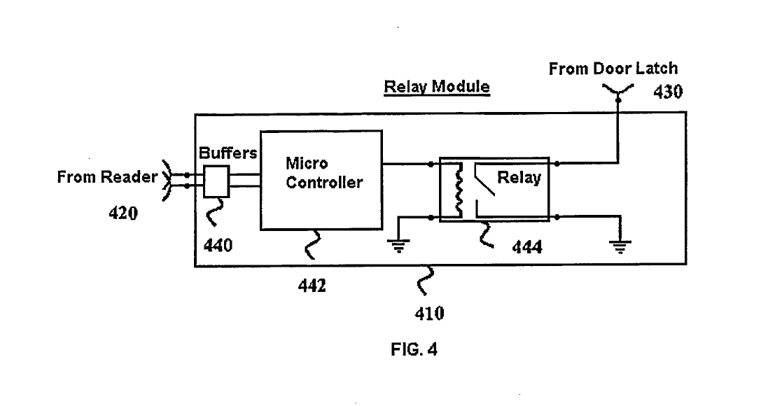

FIG. 4 is a block diagram of a relay module 400, with which the embodiment of FIG. 1 may be practiced. The relay module 400 comprises buffers 440, a micro-controller 442, and a relay 444. The relay module 400 receives communications 420 from the reader, which are input to the buffers 440, which in turn are coupled to the micro-controller 442. The micro-controller 442 operates the relay 444 in a conventional manner. The relay 444 bas an output to actuate the door latch 430.

The relay module 410 is the equivalent of a switch. If the relay module 410 receives the correct code from the reader, the relay module 410 throws the relay 444 that unlocks the door. The buffers 440 ensure that if a spike occurs in communications between the reader and the relay module 410, the micro-controller 442 is not damaged. The buffers 440 also ensure that any voltage level lost between the reader and the relay module 410 is recovered.

The micro-controller 442 decrypts the encrypted communications from the reader and compares the decrypted communications to the code expected. If this is correct, the micro-controller 442 enables the relay 444. The relay 444 switches power to actuate the door latch 430. If enabled, power runs through the door latch 430, unlocking the door.

FIG. 3 illustrates operation of the access control system 300. The reader 310 has a database on board and is located on the unsecured side. The reader 310 communicates with the relay module 320 using encrypted communications. If a user attempts to access the secure area using the reader 310, the reader 310 looks up the user data in the database and determines the access level. If the user is permitted access, the reader 310 sends an access command to the relay module 320 via the encrypted communications. In turn, the relay module 320 on the secure side activates the door latch 330.

### Anti-Passback

The embodiments of the invention provide anti-passback by placing an indicator or flag on a smartcard once a user has passed through an entry door. This ensures that the Same smartcard cannot be used on the same entry reader 110 until the smartcard has been presented to the exit reader. The flag is a composite bit field of the current entry status at different levels (i.e., different sets of entry and exit doors). Thus, the corresponding flag bit (if unset) is set if entering a set of entry/exit doors, and is unset, if leaving the flag bit (if set). Any violation of this principle is an anti-passback violation.

Normally, the anti-passback action is implemented on a controller, but in the embodiments of the invention is implemented partly on the reader 110 and partly on the smartcard. For software ease of use, the software has options to reset the anti-passback status of the card (ignore and set) and to disable anti-passback for a particular cardholder. Both of these options are downloaded to the reader with the use of various status bits in a cardholder's permission record.

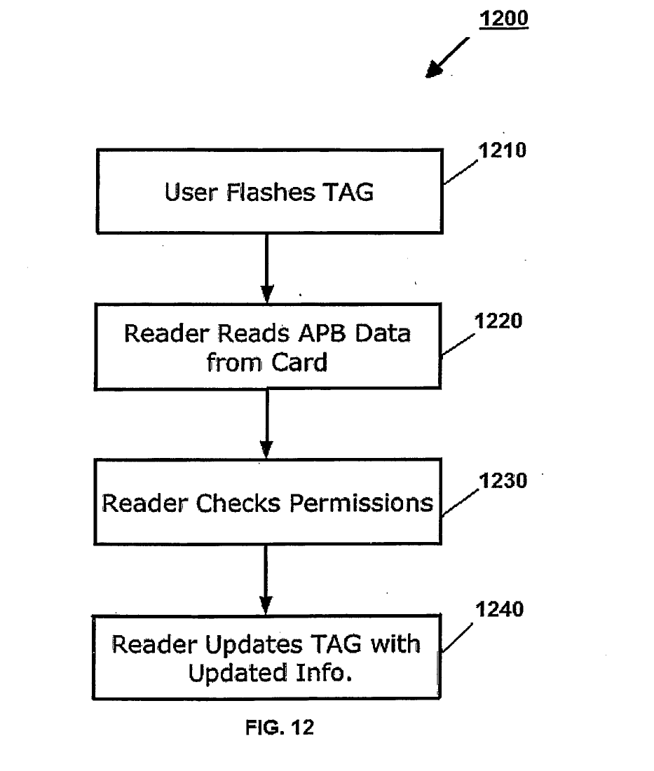

FIG. 12 is a flow diagram the antipassback (APB) feature 1200 implemented in the access control system. In step 1210, the user flashes the tag. In step 1220, the reader reads the APB data from the card. In step 1230, the reader checks permissions based on the read APB data. In step 1240, the reader updates the tag with updated information.

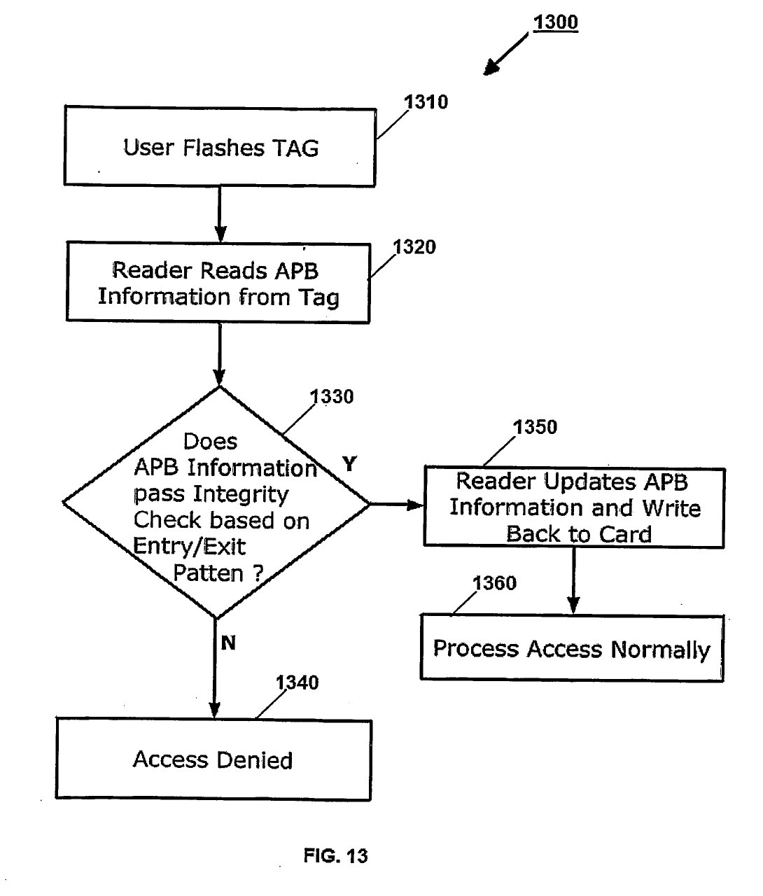

FIG. 13 is a more detailed flow diagram of normal operation 1300 of the antipassback feature. In step 1310, the user flashes the tag to a reader. In step 1320, the reader reads the APB information from the tag. In step 1330, a check is made to determine if the APB information passes an integrity check based on entry/exit patterns. If step 1330 returns false (No), access is denied in step 1340. Otherwise, if decision step 1330 returns true (Yes), processing continues at step 1350. In step 1350, the reader updates APB information and write the information back to the tag/card. Instep 1360, access is processed normally.

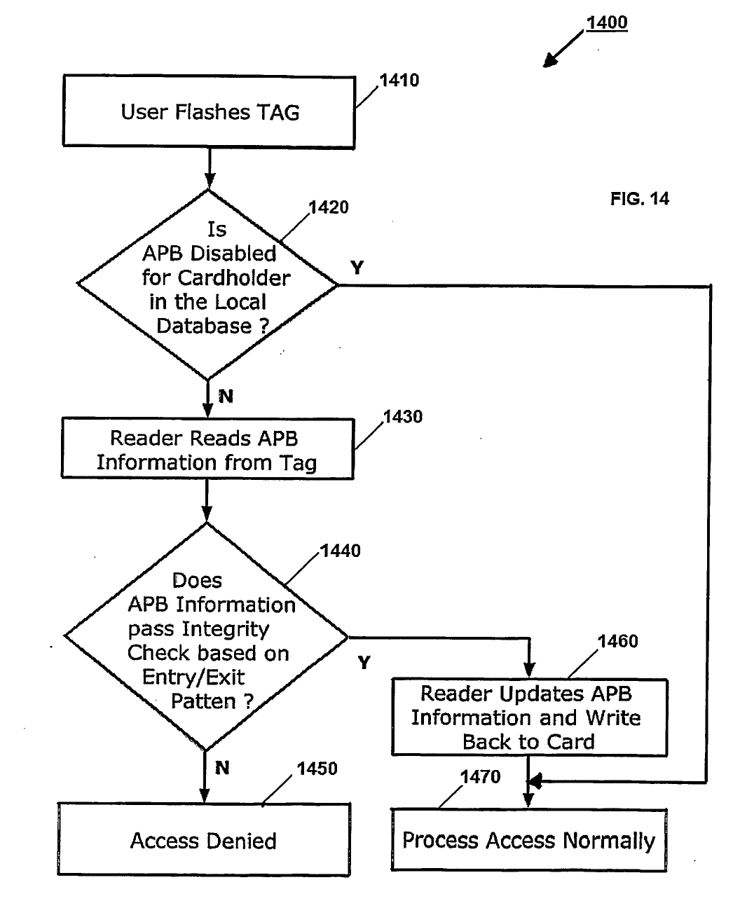

FIG. 14 is a more detailed flow diagram of disabled operation 1400 of the antipassback feature. In step 1410, the user flashes the tag to a reader. In decision step 1420, a check is made to determine if the APB feature is disable for the cardholder in the local database. If step 1420 returns true (Yes), processing continues at step 1470 and access is processed normally. Otherwise, if decision step 1420 returns false (No), processing continues at step 1430. In step 1430, the reader reads the APB information from the tag. In decision step 1440, a check is made to determine if the APB information passes an integrity check based on entry/exit patterns. If step 1440 returns false (No), access is denied in step 1450. Otherwise, if decision step 1440 returns true (Yes), processing continues at step 1460 in step 1460, the reader updates the APB information and writes the information back to the tag/card. Processing then continues at step 1470, in which access is processed normally. Thus, the disable operation 1400 of APB allows the APB feature to be disabled for the cardholder on all readers.

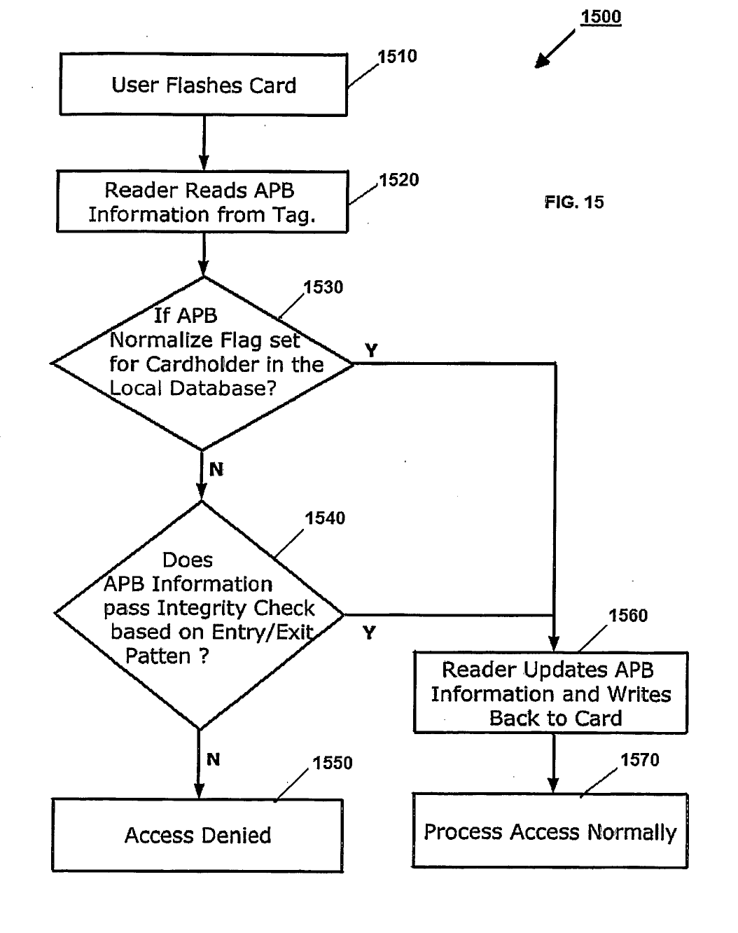

FIG. 15 is a more detailed flow diagram of normalized operation 1500 of the antipassback feature in a reader. In step 1510,; the user flashes the tag to the reader. In step 1520, the reader reads the APB information from the tag. In decision step 1530, a check is made to determine if the APB normalize flag is set for the cardholder in a local database. If step 1530 returns true (Yes), processing continues at step 1560. In step 1560, the reader updates the antipassback information and writes the updated information back to the card/tag. In step 1570, access is processed normally. Otherwise, if decision step 1530 returns false (No), processing continues at decision step 1540. In step 1540, a check is made to determine if the APB information passes an integrity check based on entry/exit patterns. If step 1540 returns false (No), processing continues at step 1550 and access is denied. Otherwise, if step 1540 returns true (Yes), processing continues at step 1560. The corresponding process on the server is described hereinafter.

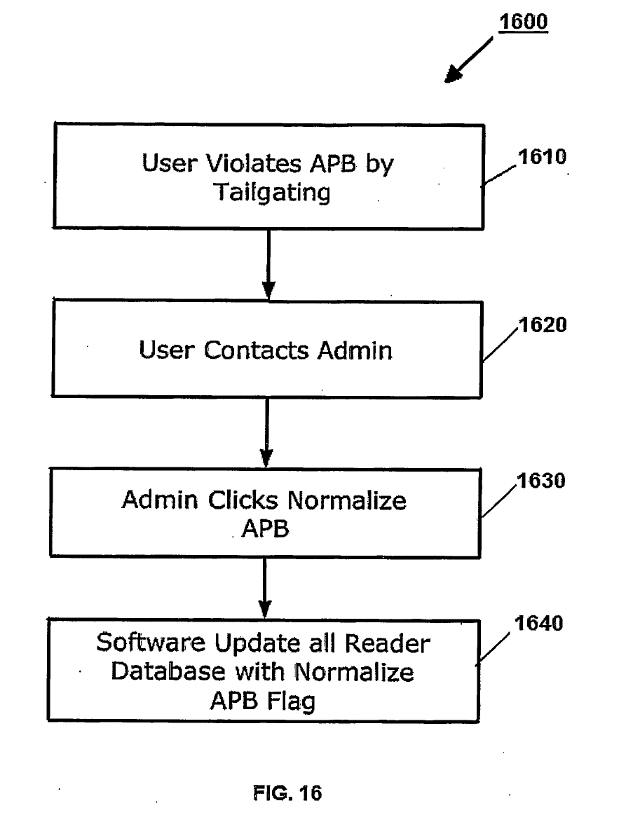

FIG. 16 is a detailed flow diagram of normalized operation 1600 of the antipassback feature as implemented in,the server. In step 1610, a user violates the antipassback feature (e.g., by tailgating another user). This results in the user not being granted access elsewhere, so in step 1620 the user notifies the system administrator about this circumstance. In step 1630, the administrator activates the normalize APB feature for the user. For example, this may be done using a graphical interface requiring the administrator to click a software option. In step 1640, the software updates the database of all readers with the normalize APB flag for the user. Thus, the normalize APB feature allows a user to proceed through any antipassback areas without violating the APB rules for a specified number of times, e.g. one time only. This can be used to allow a cardholder who has violated APB rules to continue using the readers until the user normalizes the user's APB status.

Encrypted Communications

The system 100 can ensure that communications between a roaster computer and the readers are encrypted. The type of encrypted communication can be 128-bit AES, 3DES, DES, or skipjack. Other encryption techniques may be practiced as well. The server may also provide interface management. The readers can run offline. The reader operates even if the server is down The reader may store up to 20,000 transactions, however, other numbers of transactions may be stored without departing from the scope and spirit of the invention. For example, if a larger capacity memory is used in the readers, larger numbers of transactions may be stored

### Communications Relay

The relay module 120,410 communicates using encryption (e.g., 128-bit AES, 3DES, DES or skipjack) with a corresponding reader 110. Upon receiving an activation code, the relay module 120, 410 activates the door strike 130,430. This ensures that even with access to the power and communication wires at the back of the reader 110, access cannot be forced.

### Biometrics on Card

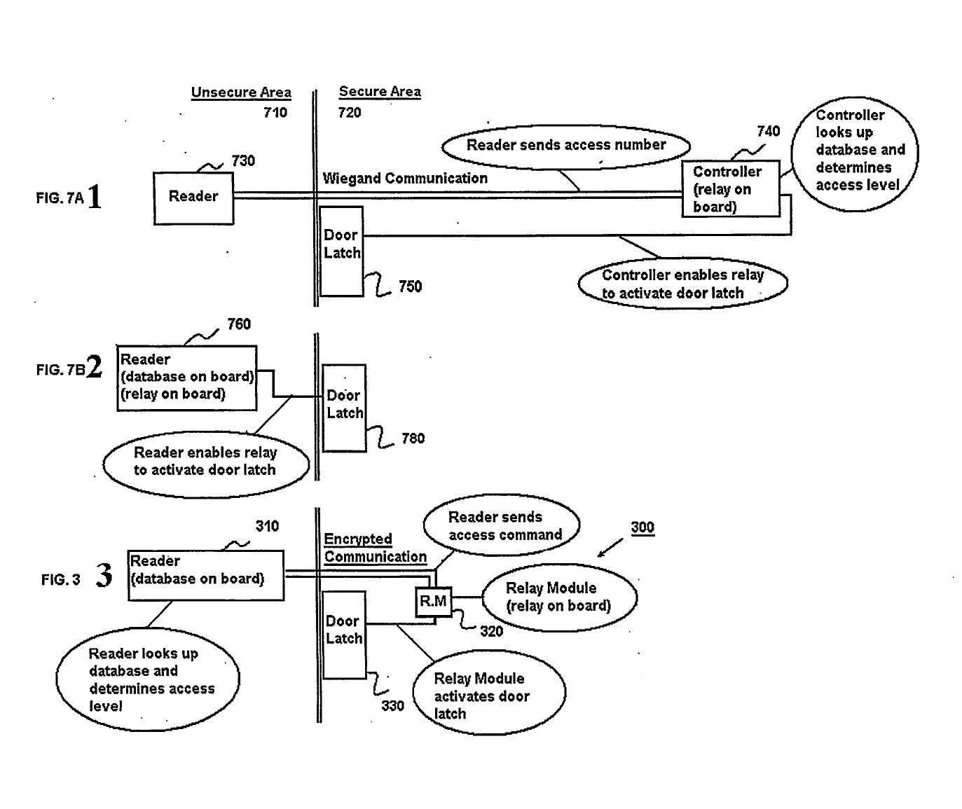

Other embodiments of the invention can be practiced using biometrics. FIG. 2 illustrates an access control system 200 in accordance with a further embodiment of the invention. The access control system 200 comprises a biometric reader 210, a storage relay module (SRM) 220, and a door latch 230. Through the use of the storage relay module 220, the reader 210 can be integrated into the access control system 200. One smartcard can store all information needed for the access control system 200, as well as a biometric fingerprint template. If BanqueTec BT910 readers are used throughout a facility, a biometric verification can be enforced before access is granted. The database and interfacing to the master computer is done via the Storage Relay Module (SRM) 220. The SRM 220 comprises an RS485 interface, memory for a database, and standard relay module functions. The SRM 220 has been designed to minimise changes to the BQT Solutions BT910. The SRM is based on the BT816 reader, without Mifare. The BT910 sends an encrypted access code and the SRM searches its database and, if a match is found, powers the door latch through its relay. The SRM also communicates with software through an RS485 link. All database updates, functions, anti passback, etc., are kept on the SRM. The BT910 does not hold the database. The SRM allows any reader that does not have a database, to be used in the embodiments of the invention. The BT910 does not contain these functions and so is complemented by the SRM 220 to be able to work on the access control system.

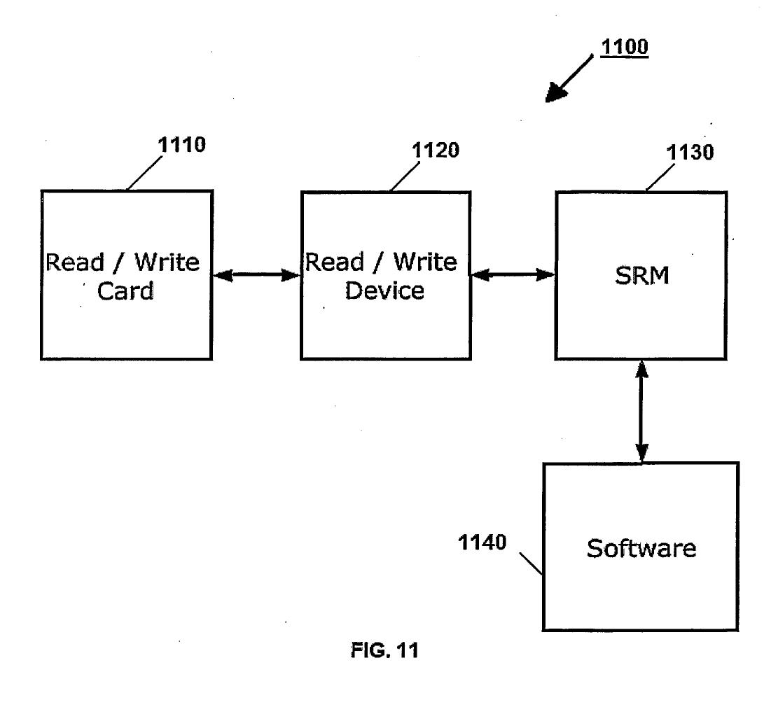

FIG. 11 is a block diagram of an access control system 1100. A read/write card 1110 is presented or flashed to a read/write device 1120, which is coupled to a storage relay module 1130. In turn the SRM 1130 is coupled to software 1140.

### Access Control Systems

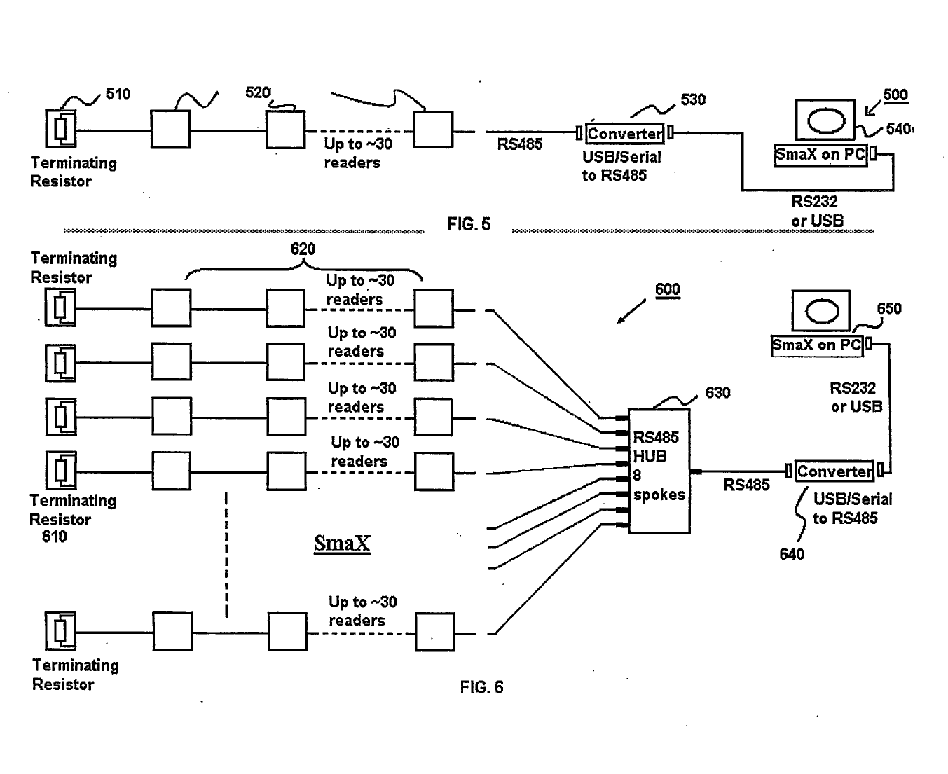

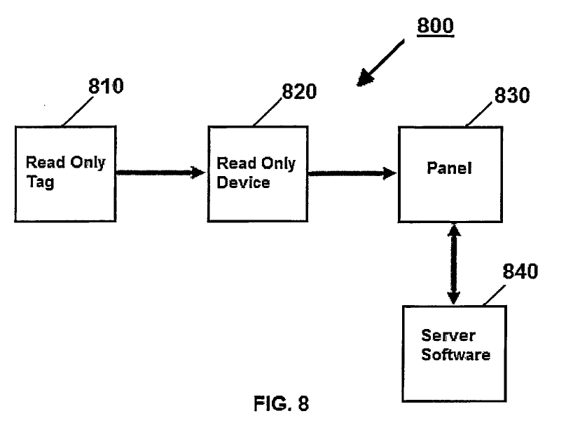

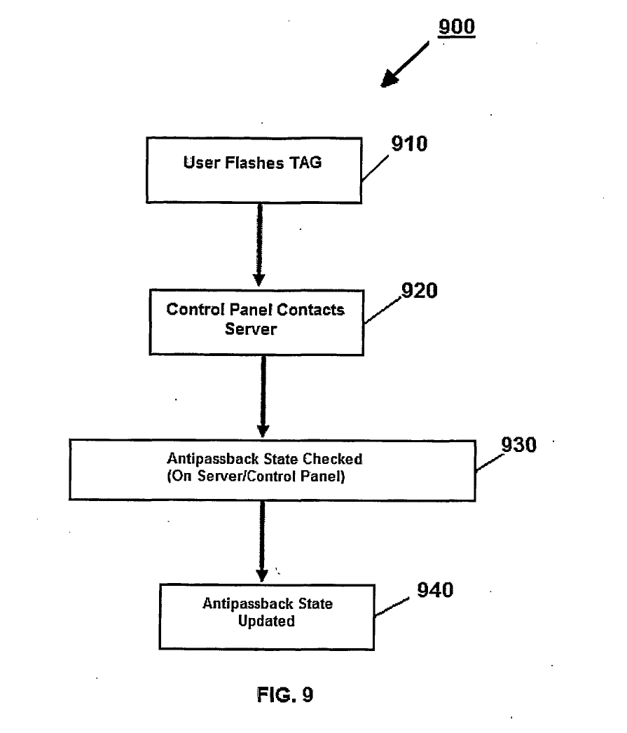

FIG. 5 shows one configuration of an access control system 500 in accordance with the embodiments of the invention. The details of the relay modules and the door lock are not depicted to simplify the drawing. A number of readers 520 can be coupled together using RS485 with a terminating resistor 510 at one end. At the other end, a converter 530 may be used to convert RS 485 to USB/Serial communications, and vice versa. The converter 530 is coupled to the master computer or server 540 using RS 232 or USB communications. The computer 540 has access control software installed in the computer 540 to interface with the readers 520. A converter is used to enable communications from the computer via a serial interface (e.g., RS232 or USB) to readers on the network (e.g., RS485). Readers may be connected in parallel across an RS485 network, and a terminating resistor may be used on the end of each line to ensure good RS485 communications.

FIG. 6 shows another configuration of an access control system 600 like that of FIG. 5, but using an RS485 hub 630. In this embodiment, the hub 630 has B spokes but other numbers of spokes may be practiced. Each spoke has up to 30 readers 620 coupled to it, and there is a terminating resistor 610 at the end of each sequence of readers 620. The hub 630 is in turn coupled to a converter 640, which is coupled to the computer or server 650. While up to 30 readers are described with reference to the drawings, the number of readers may be much higher than 30. An installer may be able to install more than 30 readers. It will be appreciated by those skilled in the art that other numbers of spokes and readers may be practiced without departing from the spirit and scope of the invention.

By having a reader contain both smartcard reading capabilities and database abilities, the use of a controller is eliminated. Further, by using encrypted communications, the limitations of Wiegand communications is eliminated as a possible communication weak link. This allows small to medium sized companies to save while still obtaining an improved security system.

A relay module for connection to a door latch in a secure area, a method of switching a door latch in a secure area, an access control system, a method of controlling access to a secure area and a method of providing antipassback in an access control system have been disclosed. While a number of specific embodiments have been described, it will be apparent to those skilled in the art in the view of the disclosure herein that modifications and substitutions may be made without departing from the scope and spirit of the invention.

1. A relay module for connection to a door latch in a secure area, comprising:
a micro-controller decrypting encrypted communications from a reader in an unsecured area and comparing the decrypted communications to an expected code; and
a relay coupled to said micro-controller switching power to actuate said door latch if the comparison of said decrypted communications and said expected code indicates a correct match.

2. The relay module of claim 1, wherein said relay module and said door latch are a single module.

3. The relay module of claim 1, wherein said micro-controller enables said relay if the comparison indicates a correct match.

4. The relay module of claim 3, wherein if said relay is enabled, power runs through said door latch to unlock a door.

5. The relay module of claim 1, further comprising at least one buffer coupled to said micro-controller for receiving said encrypted communications from said reader.

6. The relay module of claim 5, wherein said at least one buffer protects said micro-controller from being damaged if a spike occurs in said communications between said reader and said relay module.

7. The relay module of claim 5, wherein said at least one buffer rectifies any voltage level drop between said reader and said relay module.

8. A method of switching a door latch in a secure area, said method comprising the steps of:
decrypting encrypted communications from a reader in an unsecured area and comparing the decrypted communications to an expected code; and
switching power to actuate said door latch if the comparison of said decrypted communications and said expected code indicates a correct match.

9. The method of claim 8, wherein a micro-controller implements said decrypting and comparing steps.

10. The method of claim 9, wherein a relay coupled to said micro-controller implements said switching step.

11. The method of claim 10, wherein said relay module and said door latch are a single module.

12. The method of claim 9, wherein said micro-controller enables said relay if the comparison indicates a correct match.

13. The method of claim 12, wherein if said relay is enabled, power runs through said door latch to unlock a door.

14. The method of claim 8, further comprising the step of receiving said encrypted communications from said reader.

15. The method of claim 14, wherein at least one buffer coupled to said micro-controller implements said receiving step.

16. The method of claim 15, wherein said at least one buffer protects said micro-controller from being damaged if a spike occurs in said communications between said reader and said relay module.

17. The method of claim 15, wherein said at least one buffer rectifies any voltage level drop between said reader and said relay module.

18. An access control system, comprising:
a reader located in an unsecured area for determining access rights in response to presentation of a card and generating encrypted communications;
a relay module located in a secure area for receiving said encrypted communications from said reader, decrypting said encrypted communications, and comparing the decrypted communications to an expected code;
a door latch coupled to said relay module, said door latch actuated by said relay module switching power if the comparison of said decrypted communications and said expected code indicates a correct match.

19. The access control system according to claim 18, wherein said generated encrypted communications comprises an access command for said relay module.

20. The access control system according to claim 18, wherein said door latch is directly connected to said relay module.

21. The access control system according to claim 20, wherein said relay module and said door latch are a single module.

22. The access control system according to claim 18, wherein said reader comprises logic functions and a database residing in said reader.

23. The access control system according to claim 22, wherein said database holds information including access times, users, hot-listing, holidays, and the like.

24. The access control system according to claim 22, wherein said reader is autonomous if communications are cut or a master computer is brought down.

25. The access control system according to claim 18, wherein said reader is a smartcard reader and said card is a smartcard.

26. The access control system according to claim 25, wherein said smartcard implements an anti-passback feature.

27. The access control system according to claim 18, wherein said reader is a biometric reader.

28. The access control system according to claim 18, wherein said relay module is a storage relay module.

29. The access control system according to claim 18, wherein said relay module comprises:
a micro-controller for decrypting encrypted communications from a reader in an unsecured area and for comparing the decrypted communications to an expected code; and
a relay coupled to said micro-controller for switching power to actuate said door latch if the comparison of said decrypted communications and said expected code indicates a correct match.

30. The access control system according to claim 29, wherein said relay module further comprises at least one buffer coupled to said micro-controller for receiving said encrypted communications from said reader.

31. The access control system according to claim 18, wherein said communications are encrypted using 128-bit AES, 3DES, DES, or skipjack.

32. A method of controlling access to a secure area, said method comprising the steps of:
determining access rights using a reader located in an unsecured area in response to presentation of a card and generating encrypted communications;
receiving said encrypted communications from said reader using a relay module located in a secure area for, decrypting said encrypted communications, and comparing the decrypted communications to an expected code; and
actuating a door latch coupled to said relay module using said relay module by switching power if the comparison of said decrypted communications and said expected code indicates a correct match.

33. The method according to claim 32, wherein said generated encrypted communications comprises an access command for said relay module.

34. The method according to claim 32, wherein said door latch is directly connected to said relay module.

35. The method according to claim 34, wherein said relay module and said door latch are a single module.

36. The method according to claim 32, wherein said reader comprises logic functions and a database residing in said reader.

37. The method according to claim 36, wherein said database holds information including access times, users, hot-listing, holidays, and the like.

38. The method according to claim 36, wherein said reader is autonomous if communications are cut or a master computer is brought down.

39. The method according to claim 32, wherein said reader is a smartcard reader and said card is a smartcard.

40. The method according to claim 39, wherein said smartcard implements an anti-passback feature.

41. The method according to claim 32, wherein said reader is a biometric reader,

42. The method according to claim 32, wherein said relay module is a storage relay module.

43. The method according to claim 32, wherein said relay module comprises:
a micro-controller for decrypting encrypted communications from a reader in an unsecured area and for comparing the decrypted communications to an expected code; and
a relay coupled to said micro-controller for switching power to actuate said door latch if the comparison of said decrypted communications and said expected code indicates a correct match.

44. The method according to claim 43, wherein said relay module further comprises at least one buffer coupled to said micro-controller for receiving said encrypted communications from said reader.

45. The method according to claim 32, wherein said communications are encrypted using 128-bit AES, 3DES, DES, or skipjack.

46. A method of providing antipassback in an access control system, said method comprising the steps of
reading antipassback information from a read/write smartcard presented to a read/write reader;
checking permissions using said read/write reader; and
updating said read/write smartcard with updated antipassback information using said reader.

47. A method of providing antipassback in an access control system, said method comprising the steps of:
reading antipassback information from a read/write smartcard presented to a read/write reader;
determining if said antipassback information passes an integrity check based on an entry/exit pattern; and
if the antipassback information passes the integrity check, writing updated antipassback information to said read/write smartcard and granting access.

48. The method according to claim 47, further comprising the step of, if the antipassback information fails to satisfy the integrity check, denying access.

49. The method according to claim 46, wherein said antipassback is able to be disabled.

50. The method according to claim 46, wherein said antipassback is able to be normalized so that a cardholder may proceed through an antipassback area without violating antipassback rules.

51. The method according to claim 50, wherein a database of readers is updated with an antipassback flag.
